(19) United States
(12) Patent Application Publication
(10) Pub. No.: US 2007/0090237 A1
(43) Pub. Date: Apr. 26, 2007

(54) Camera tripod

(76) Inventor: Chen Jen Hsu, Taoyuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/246,878

(22) Filed: Oct. 7, 2005

(51) Int. Cl. F16M 11/02

(52) U.S. Cl. 248/178.1; 248/177.1

(57) ABSTRACT

A camera tripod includes a mounting platform assembly and a tripod adjusting means. The mounting platform assembly includes a base and a platform. A handle is provided beneath the base. When the handle is loosened, the inclination of the platform can be controlled, but when the handle is locked, the inclination is fixed. The tripod adjusting means is mounted on the periphery of the base. The adjusting means includes supporting legs and tabs with stepped portions provided on the periphery of the base. Further, positioning elements and elastic elements are provided between the supporting legs and the tabs. The elastic element applies a resistant force to hold the positioning element between the tab and the supporting leg. The positioning element can escapes from the stepped portions of the tab to adjust the inclination of the supporting leg.

### BACKGROUND OF THE INVENTION

1. Field of the Invention

The present invention relates to a tripod for mounting a camera or video camera.

2. The Prior Arts

A tripod is a necessary instrument for a photographer to perform long time exposure or pursue more stable images. Especially, an expert photographer really needs a tripod with excellent stability, reliability and operability. No matter an amateur or professional tripod, a mounting platform assembly is often mounted on the tripod. A top end of the mounting platform assembly is adapted to fix a camera or video camera thereon, and the inclination of the mounting platform assembly can be adjusted.

The conventional mounting platform assembly of the tripod comprises a horizontal angle controlling means and an elevation angle controlling means for adjusting its inclination. The horizontal angle controlling means is adapted to control the rotation of the mounting platform assembly in the horizontal direction to adjust the horizontal angle, and then lock it in a desired angle. The elevation angle controlling means is adapted to control the inclination of the mounting platform assembly in the vertical direction to adjust the elevation angle, and then lock it in a desired angle. In other words, the conventional tripod for a camera has the following drawbacks:

(1) The structure for the angle adjustment of the mounting platform assembly is a two-dimensional control structure comprising the horizontal controlling means and the vertical controlling means. With the operation of the two-dimensional control structure, a desired angle of the mounting platform assembly can be obtained. Therefore, the user should operate two controlling means to adjust the angle of the mounting platform assembly. Such operation is more complicated and less convenient.

(2) Expert photographers sometimes use a single-legged stand for flexible operation. A top end of the single-legged stand is also provided with a mounting platform assembly for directly mounting a camera or video camera thereon. In operation, the photographer should keep the stand stable by his/her hands. However, conventional tripods cannot provide the functions of the single-legged stand, the photographer should additionally buy a single-legged stand, resulting in more cost and weight of photographic instruments. Further, the flexibility of photographing in outdoors will thus be adversely affected.

(3) Since the conventional tripod is not provided with a camera balancing device, users should additionally buy and assemble the related elements if needed, resulting in waste of money and time.

(4) Conventional art cannot be arbitrarily and fast adjusted to a desired angle.

### SUMMARY OF THE INVENTION

An object of the present invention is to integrate the two-dimensional control means of the mounting platform assembly of the conventional tripod, such that users can simply control the horizontal and elevation angles of the mounting platform assembly.

To achieve the above-mentioned objects, a camera tripod in accordance with the present invention comprises a mounting platform assembly and a tripod adjusting means. The mounting platform assembly comprises a base and a platform.

The platform and the base are assembled through their respective sphere and spherical recess complementary to each other. A rotatable handle is provided beneath the base. When loosening the handle, users can adjust the inclination of the platform, whereas when locking the handle, users can fix the inclination of the platform. The tripod adjusting means is provided on the periphery of the base. The adjusting means includes supporting legs and tabs with stepped portions provided on the periphery of the base, and positioning elements and elastic elements are provided between the supporting legs and the tabs. The elastic element can apply a resistant force to hold the positioning element between the tab and the supporting leg. A projection is provided under the positioning element for preventing the positioning element from escaping out of the supporting leg, but the positioning element is able to escape from the stepped portion of the tab to adjust the inclination of the supporting leg. The present invention further comprises another mounting platform assembly, which can be mounted on one supporting leg for use.

Another characteristic of the present invention is that when one supporting leg can be detached from the tripod and another mounting platform assembly is assembled thereon, that can be used as a single-legged stand.

Also another characteristic of the present invention is that the spherical recess on the base and the sphere on the platform can be detached from their respective the platform and the base, and a mounting member of the platform is directly mounted on the base, so as to form a new tripod unable to rotate and adjust the angle.

Yet another characteristic of the present invention is that each supporting leg comprises a plurality of tubular bodies and is made of aluminum alloy. As a result, the leg frame is not bulky and heavy. A nut having inner threads mounts on outer threads of two adjacent tubular bodies to lock them together and elongate the length of the supporting leg. In this way, a multiple-stage adjustable tripod can be formed, and the supporting legs can be retracted into the tubular bodies after loosening the nuts, such that the whole volume of the tripod can be greatly reduced and easy to carry.

In comparison with the conventional camera tripod, the present invention integrates the two-dimensional control means of the mounting platform assembly of the conventional tripod, such that users can simply control the horizontal and elevation angles of the mounting platform assembly. In this way, the present invention makes the operation easier, the structure simpler, and the production cost lower. Further, the present invention can be used as a single-legged stand.

### BRIEF DESCRIPTION OF THE DRAWINGS

FIG. 1 is a perspective view showing an external structure of a camera tripod in accordance with the present invention;

FIG. 2 is an exploded view of the camera tripod of the present invention;

FIG. 3 is a cross-sectional view showing a mounting platform assembly of the present invention;

FIG. 4 is a cross-sectional view showing the action of controlling the inclination of the mounting platform assembly of the present invention;

FIG. 5 is a cross-sectional view showing a tripod adjusting means of the present invention;

FIG. 6 is a plan view showing the action of the tripod adjusting means of the present invention, in which the tripod adjusting means is controlled to adjust the angle of supporting legs;

FIG. 7 is an exploded view of another mounting platform assembly in accordance with the present invention, showing that after one supporting leg is detached, the mounting platform assembly can be further assembled with the single supporting leg;

FIG. 8 is a assembled view of FIG. 7; and

FIG. 9 is a cross-sectional view showing that a mounting member of a platform of the mounting platform assembly is directly mounted on a base thereof.

### DETAILED DESCRIPTION OF THE PREFERRED EMBODIMENT

The detailed description of the present invention is made with reference to the drawings and reference numerals of elements. Those skilled in this art can thus implement the present invention in view of the teachings of this specification.

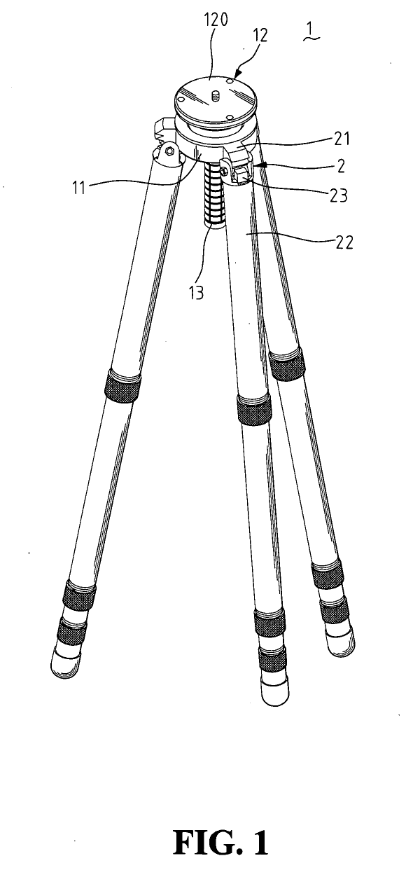

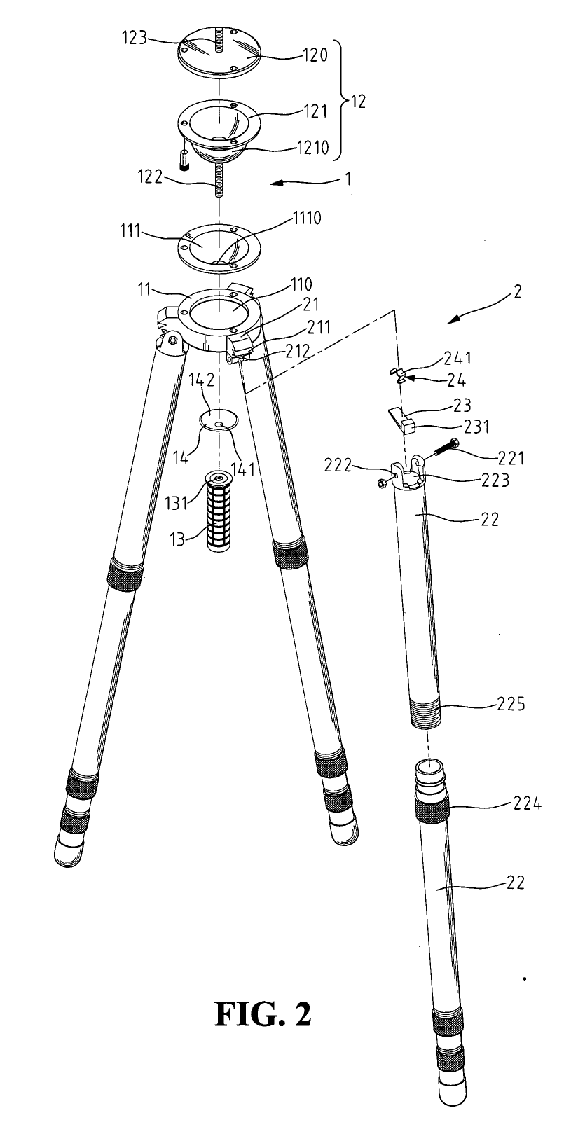

Referring to FIGS. 1 and 2, the present invention comprises a mounting platform assembly 1 and a tripod adjusting means 2. The mounting platform assembly 1 comprises a base 11, a platform 12 and a handle 13. A through hole 110 is provided in a center of the base 11. Three tabs 21 are provided in the periphery of an outer periphery of the base 11 with an angular interval of 120 degrees. The outside face of each tab 21 is provided with a plurality of stepped portions 211, and a grove 212 having a suitable width is provided on a lower end of the stepped portion 211. Each tab 21 is provided with a hole on both sidewalls thereof. A spherical recess 111 having a central hole 1110 and a flange is mounted on the base 11 by bolts and nuts, in which a concave surface of the spherical recess 111 faces upward. The platform 12 is provided on the base 11 and comprises a mounting member 120 and a base member 121. A bottom of the base member 121 is provided with a sphere 1210. A lower screw rod 122 is centrally provided on a lower end of the sphere 1210. An upper screw rod 123 is centrally provided on the mounting member 120 for connecting with a camera.

The base member 121 and the mounting member 120 can be integrally fixed each other by using bolts and nuts. The mounting platform assembly 12 of the present invention also comprises a handle 13 and a pad 14. The pad 14 is provided with a concave surface 142 corresponding to a radian of the bottom of the spherical recess 111, and also provided with a penetrating hole 141 in a center thereof. One end of the handle 13 is provided with a screw hole 131.

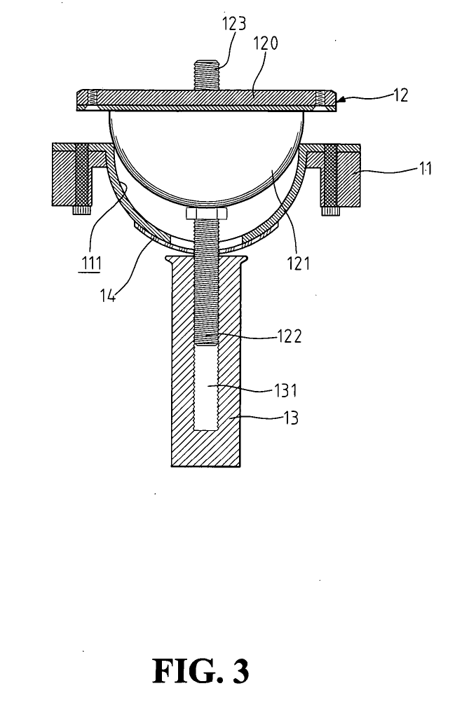

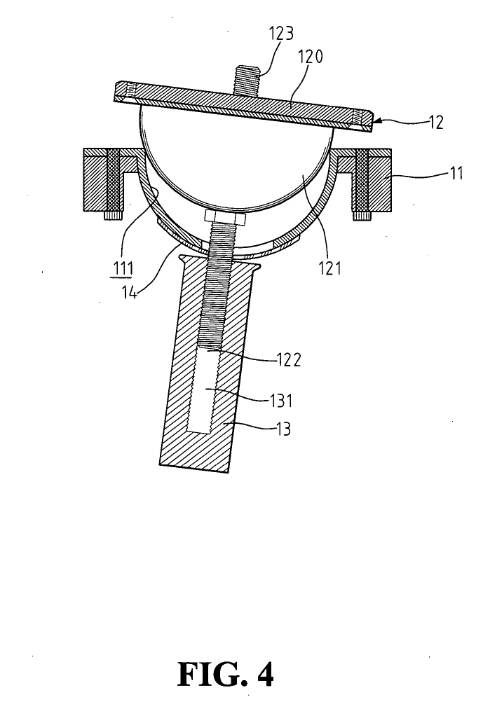

After the lower screw rod 122 of the platform 12 penetrates through the central hole 1110 of the spherical recess 111 and the penetrating hole 141 of the pad 14, the lower screw rod 122 can be locked into the screw hole 131 of the handle 13. As a result, when the handle 13 is locked, the pad 14 can be forced to abut against the bottom of the spherical recess 111, such that the platform 12 cannot rotate in the spherical recess 111 (see FIG. 3). On the contrary, when the handle 13 is loosened, since the pad 14 does not abut against the bottom of the spherical recess 111 any more, the sphere 1210 of the platform 12 can be controlled to rotate in the spherical recess 111 by operating the handle 13 (see FIG. 4). In this way, the angle adjustment of the platform 12 can be achieved.

The tripod adjusting means 2 of the present invention comprises tabs 21, supporting legs 22, positioning elements 23 and elastic elements 24. The tabs 21 are provided in the periphery of the base 11 in an equiangular manner. The supporting legs 22 are connected to the tabs 21. Each tab 21 has a plurality of stepped portions 211. A lower end of each tab 21 is formed with a groove 212 having a suitable width. An upper end of each supporting leg 21 is provided with a notch 223 having apertures 222 on both sidewalls. Thus, the tab 21 provided in the periphery of the base 11 can be inserted into the notch 223. A shaft 221 is penetrated through the apertures 222 and the hole of the tab 21 to pivotably connect the supporting leg 22 with the tab 21.

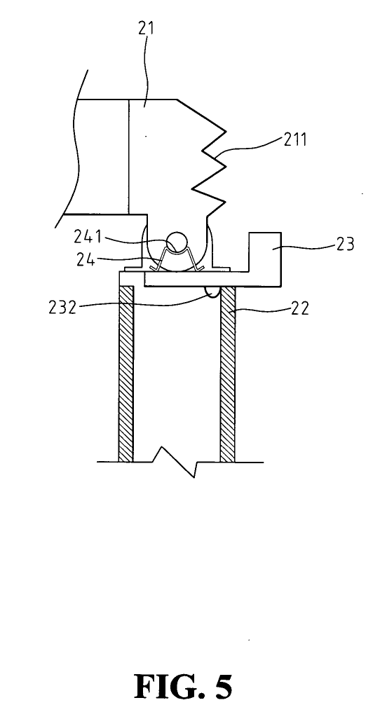

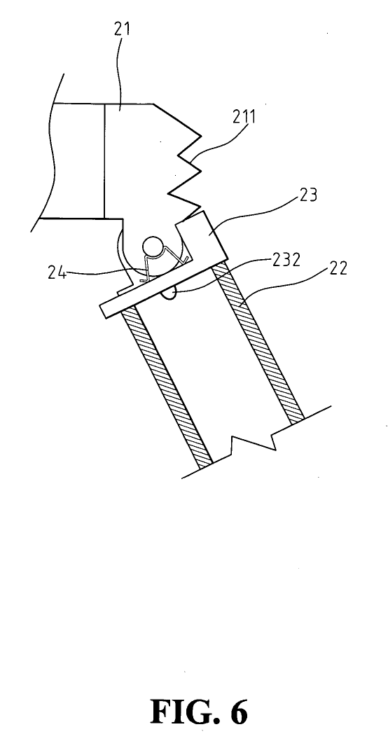

In order to adjust the inclination of the supporting leg 22, the present invention provides a positioning element 23 and an elastic element 24 between the notch 223 of the supporting leg 22 and the tab 21. In an embodiment of the present invention, the positioning element 23 is a L-shaped body having a drawing end 231 projecting from one end of the positioning element 23. Further, a projection 232 (see FIG. 5) is provided on a lower surface of the positioning element 23. The elastic element 24 is an elastic steel sheet with a [symbol] -shaped portion. A concave 241 is formed on an upper surface of the [symbol] -shaped portion. The positioning element 23 is inserted into the notch 223 of the supporting leg 22, and the elastic element 24 is positioned on the positioning element 23 and in the groove 212 of the tab21. Further, a concave 241 of the elastic element 24 abuts against the shaft 221, such that the elastic element 24 applies an elastic force to the positioning element 23 to produce a damping effect. In this way, when the drawing end 23 is drawn outward, an upper edge of the drawing end 23 escapes from the stepped portion 211 of the tab 21 (see FIG. 5), such that the inclination of the supporting leg 22 can be adjusted. After completing the above adjustment, the positioning element 23 is pushed into the notch 223, such that the upper edge of the drawing end 23 abuts against one of the stepped portions 211 to fix the supporting leg 22 (see FIG. 6)

Further, according to the present invention, the supporting leg 22 comprises a plurality of tubular bodies connecting to each other in series. One tubular body is provided with outer threads on its end, and the other tubular body is provided with a nut 224 having inner threads. By threading the nut 224 into the outer threads 225, two tubular bodies can be locked and connected in series to form a long supporting leg. When the nut 224 is loosened, the supporting legs coaxially connected to each other can be retracted or extended to a desired length.

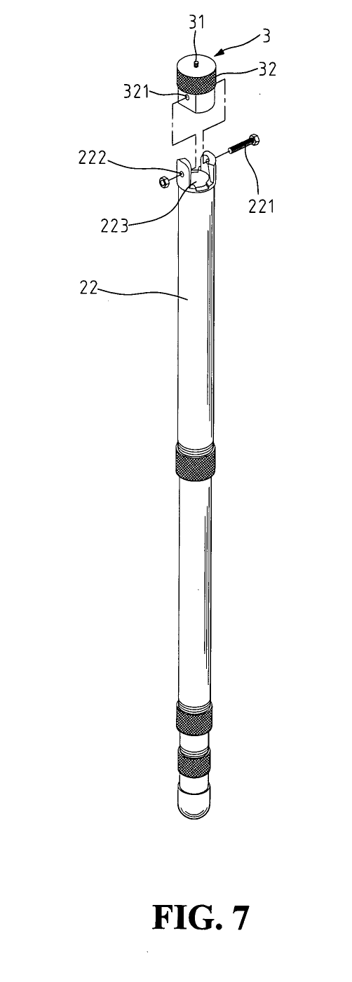

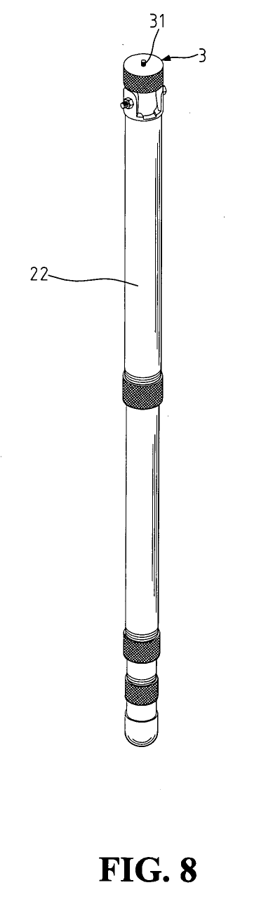

Referring to FIG. 7, another mounting platform assembly 3 is provided, which has a seat portion 32 and can be received in the notch 223 of one supporting leg 22. The seat portion 32 is provided with a transversely penetrating hole 321. A screw rod 31 is provided on a top surface of the mounting platform assembly 3 for assembling a camera or video camera. When photographers need to use a single-legged stand, they can detach one supporting leg 22 from the tripod, and then insert the seat portion 32 of the mounting platform assembly 3 into the notch 223 of the supporting leg 22. After this, the shaft 221 is penetrated through the apertures 222 on both sidewalls of the notch 223 and the hole 321 of the seat portion 231, such that the mounting platform assembly 3 can be fixed on the upper end of the supporting leg 22 (see FIG. 8). In this way, they can mount a camera or video camera on the mounting platform assembly 3 for use.

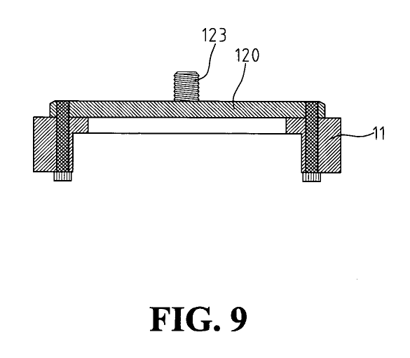

Referring to FIG. 9, which shows another embodiment of the present invention, in this embodiment, the spherical recess 111 (see FIG. 2) can be detached from the base 11, and the base member 121 connecting with the sphere 1210 can be detached from the mounting member 120. Then, the mounting member 120 can be directly fixed to the base 11 by bolts and nuts, such that a new mounting platform assembly unable to rotate and adjust the angle thereof can be obtained.

Although the present invention has been described with reference to the preferred embodiment thereof, it will be understood that the invention is not limited to the details thereof. Various equivalent variations and modifications can still be made in view of the teachings in the claims and specification of the present invention.

Thus, all such variations and modifications are also embraced within the scope of the invention as defined in the appended claims.

What is claimed is:

1. A camera tripod, comprising:
a mounting platform assembly, further comprising:
a base having a spherical recess with a penetrating central hole;
a platform having a sphere corresponding to the spherical recess, wherein a lower screw rod is provided beneath the sphere, and an upper screw rod is provided on the platform;
a handle having a screw hole on its upper end for threading with the lower screw rod;
a tripod adjusting means, further comprising:
a plurality of tabs provided on the periphery of the base in an equiangular manner, wherein each tab has a plurality of stepped portions;
a plurality of supporting legs each pivotably connected to the tabs, respectively;
a plurality of positioning elements each provided adjacent to the connection of the supporting leg and the tab, wherein the positioning element is movable with respect to the supporting leg to or not to abuts against the stepped portion, and a projection is provided on a lower surface of the positioning element to prevent from escaping from the projection of the supporting leg;
an elastic element each provided adjacent to the connection of the supporting leg and the tab, wherein the elastic element applies a force to the tab and the positioning element at the same time.

2. The camera tripod according to claim 1, wherein the mounting platform assembly further comprises a pad having a penetrating hole, the pad is provided between a lower surface of the base and the upper end of the screw rod, and the lower screw rod is inserted through the penetrating hole.

3. The camera tripod according to claim 1, wherein a notch is provided on an upper end of the supporting leg for receiving the tab, and a shaft is inserted through both sidewalls of the notch to pivotably connect with the tab.

4. The camera tripod according to claim 3, wherein a groove is provided on a lower surface of the tab, and the elastic element is provided in the groove.

5. The camera tripod according to claim 3 or 4, wherein the positioning element is a L-shaped body passing through the notch on the upper end of the supporting leg.

6. The camera tripod according to claim 4, wherein the elastic element is a [symbol] -shaped body, and an upper surface of the [symbol] -shaped body is formed with a concave.

7. The camera tripod according to claim 1, wherein the supporting leg comprises a plurality of tubular bodies connecting with each other in series, one tubular body is provided with outer threads on its end, the other tubular body is provided with a nut having inner threads, and the two tubular bodies are able to be locked by threading the nut onto the outer threads.

8. The camera tripod according to claim 1, further comprising another mounting platform assembly having a seat portion received in the notch of one of the supporting legs and a screw rod on a top surface thereof, in which the seat portion is provided with a transversely penetrating hole.

9. The camera tripod according to claim 1, wherein the spherical recess is a separate element from the base, which is fixed to the base by fixing elements.

10. The camera tripod according to claim 9, wherein the platform comprises a mounting member and a base member connected with each other, in which the sphere is provided beneath the base member.
